(19) United States
(12) Patent Application Publication
(10) Pub. No.: US 2007/0256004 A1
(43) Pub. Date: Nov. 1, 2007

(54) Method for validating dynamically a spreadsheet formula

(76) Inventor: Raymond Payette, Quebec (CA)

Correspondence Address: RAYMOND PAYETTE, 3475 VAUTELET #306, QUEBEC, QC, GIW 4V9, US

(21) Appl. No.: 11/413,902

(22) Filed: May 1, 2006

(51) Int. Cl. G06F 15/00

(52) U.S. Cl. 715/503; 715/538

(57) ABSTRACT

A method and a computer program are provided for displaying the result of any formula in a spreadsheet in accordance with validation conditions. In one embodiment the sum of a column is compared to the sum of a row and if the two results are equal one of the totals is displayed otherwise an error message is displayed. In another embodiment the result of any valid formula is compared to a valid condition and if the result agrees with the condition the result is displayed otherwise an error message is displayed. In the preferred embodiment the result of any valid formula is compared to a valid condition moreover another condition is tested and if the conditions are validated the result is displayed otherwise an error message is displayed and an interface signals the errors.

### TECHNICAL FIELD

This invention relates to a method of displaying spreadsheet cells so as to facilitate the identification of errors.

### BACKGROUND OF THE INVENTION

Electronic spreadsheets in particular Excel, a marketed spreadsheet whose trademark is registered by Microsoft Corporation, have become common software tools used in all kinds of business and scientific processes. Spreadsheets consist of workbooks grouping worksheets that display a grid of cells at the intersection of each row and column. A cell can contain data such as text, numbers and dates. It can also house controls such as buttons or sliders, and objects such as pictures. Cells may contain formulas that are a combination of functions, such as SUM and MAX, and data organized as arguments such as A1 that refers to a cell or B2:B7 that refers to a range of contiguous cells. As defined by Microsoft “Functions are predefined formulas that perform calculations by using specific values, called arguments, in a particular order, or structure.” and “Formulas are equations that perform calculations on values in your worksheet. A formula starts with an equal sign (=).” An example of a formula is =B2+B3+B4+B5. The addition of numbers in a range can be entered as =SUM(B2:B5). A range can also be called by a name that the user will define; for example the user can define the word ColsSum to mean the range B2:B5 in that case ColsSums is called a Defined Name. The above formula can also be entered as =SUM(ColsSums) when the range has been defined.

Recent studies have revealed that spreadsheets are very prone to errors. It is generally acknowledged that 90% of spreadsheets suffer from some error and often consequences are severe, in financial results, contract bidding and even elections. Methods exist to identify errors, select the type of errors, recommend remedies and modifying the value, still this is insufficient. Clearly there is a need to reduce all types of errors, particularly those relating to formulas.

There are many computational conventions, such as strings denoting text, as opposed to dates or numbers.

Excel already has the capacity to validate data. By selecting the Data and Validation menu options of the standard menu, the user can activate an interface that will set a validation message, the validation criteria and an output message as well as the action to be taken. This functionality does not apply to cells that have formulas.

Presently the Excel error checker identifies potential errors that meet seven kinds of error rules:

1. cells containing formulas that evaluate to an impracticable error;

2. formulas referring to empty cells;

3. numbers stored as text;

4. formulas that omit cells;

5. inconsistent formulas in a region;

6. cells containing text dates with 2 digit years;

7. and unlocked cells containing formulas.

A dynamic validation is a validation that updates itself whenever a change is made. If the user chooses, the calculations may be done manually rather than automatically thus disabling dynamic validation. The error checker is a dynamic feature. Sometimes a change causes an error in another spreadsheet or another active workbook, but Excel's error checker only displays an error in the cell. It would be advantageous to warn the user of such an occurrence wherever worksheet the user is located.

One very common formula is the addition of a row or a column of data that is cumulated in a table. At the lower right is a grand total of either the corresponding row or column, however it should be compared to the grand total of the corresponding column or row to ensure that the table foots and cross-foots. In this case equality of the two totals is the condition being tested. There is a need to validate dynamically that this equality is always true. Excel error checker does not directly provide the capability of this type of dynamic formula validation in a single formula.

Excel uses the Visual Basic programming language, more particularly Visual Basic Environment and Visual Basic for Applications.

Philip L. Bewig in his paper “How do you know your spreadsheet is right?” dated Jul. 28, 2005, proposed a function he called Assert that he states solve this crosschecking problem:

```
Function Assert(x, y, msg As String)
  If Abs(x / y − 1) < 0.0000000000001 Then
    Assert = x
  Else
    Assert =1+ msg
  End If
End Function
```

Since it did not work as stipulated, the inventor corrected it to:

```
Function Assert(x, y, msg As String)
  If Abs(x / y − 1) < 0.0000000000001 Then
    Assert = x
  Else
    Assert = msg
  End If
End Function
```

The user calls the Assert function from the spreadsheet with the following formula:

=ASSERT(SUM(RowSums), SUM(ColSums), “Row sums must equal column sums”)

This function is limited because it can only be used to compare equalities. It cannot compare “greater than” logic for example. Also it works correctly only if it uses Defined Names, in this case RowSums and ColSums. It would not work with the following formula having ranges: =ASSERT(SUM(B33:E33), SUM(F2:F32), “Row sums must equal column sums”). No warning message is displayed, though it might be advantageous to do so. There is a need to overcome these obstacles to facilitate and expand formula validation. Furthermore there is a need to optionally add more conditions.

Prior art spreadsheet functions are described in the following US patents applications: 20020023105; 20020161799; 20040103366; 20050097464.

### SUMMARY OF THE INVENTION

The object of the present invention is to devise a method for validating dynamically a spreadsheet formula with a plurality of conditions and to optionally display an interface that will signal an error message when applicable.

The present invention meets the above-described needs by providing a formula that validates a cell's result. When the cell's content does not satisfy or match a validation condition, the cell is identified as containing an error. Whenever the workbook calculations refresh, the tests are repeated, making it a dynamic formula.

The formula has at least 3 arguments, the first one being the cell's original formula, the second being a condition and the third one being an error message. As an example the original formula may be the addition of numbers in a table's column, the condition may be the addition of the footings and the third, a warning to indicate that the crosscheck is incorrect. If any amount in the table changes, when the calculations refresh the column's sum will be recalculated and the crosscheck will be retested. If the crosscheck is not equal, the cell will indicate that there is an error and an interface will appear to warn of the error. Optionally there may be another condition to test. The tests need not depend on the current cell's content; the condition may be any valid Excel formula that includes any valid functions.

The various aspects of the present invention may be more clearly understood and appreciated from a review of the following detailed description of the disclosed embodiments and by reference to the drawings and claims.

### BRIEF DESCRIPTION OF THE DRAWINGS

FIG. 1 depicts an exemplary spreadsheet table with a validating function illustrated in a formulas bar.

FIG. 2 depicts an exemplary spreadsheet table with a validating function having an optional condition with an optional message as illustrated in a formula bar.

FIG. 3 depicts an exemplary spreadsheet table with a validating function having an optional condition with an optional message illustrated in a formula bar, the result being in error.

FIG. 4 depicts an exemplary spreadsheet table with a validating function having an optional condition with an optional message illustrated in a formula bar, the result being in error and an exemplary interface warns the user of the error.

### DETAILED DESCRIPTION

A function that validates a formula with respect to a valid condition having any valid operand and any valid function and returns a result or, if the condition is not met the indication of an error. In the preferred embodiment there may be an optional condition and a related error message; the error message will combine error messages if more than one error coexist.

Exemplary embodiments of the present invention will hereinafter be described with reference to the drawing, in which like numerals represent similar elements in several of the figures.

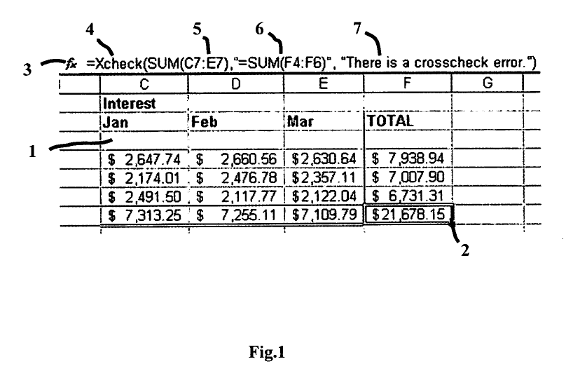

FIG. 1 is an exemplary embodiment of a portion of a spreadsheet having a table 1 of data residing in contiguous cells. A border highlights the active cell 2. That cell's content is the result of the Xcheck function that is reproduced in the formula bar 3. The exemplary function is:

=Xcheck(SUM(C7:E7),“=SUM(F4:F6)”,“There is a crosscheck error.”)

Xcheck 4, is the function name of the present invention's method. The function's arguments 5, 6 and 7, are enclosed by parentheses. Argument 5 can be any valid function, in this example SUM(C7:E7) represents the addition of row 7 from column C to column E. It may be enclosed in quotation marks. Argument 6, “=SUM(F4:F6)” is a mathematical condition that is being tested; it is enclosed between quotation marks because it is treated as strings. The equal sign is the operand of comparison to between this argument and argument 5; it could have been >=for example. SUM(F4:F6) is the argument that can be any valid function that represent the total of the sum of column 6 from row 4 to row 6. Argument 7, “There is a crosscheck error” is also enclosed in quotation marks because it represents strings. The result of this function is displayed in the active cell 2 as $21,678.15 because the total of the row 7's range is equal to the total of column F's range.

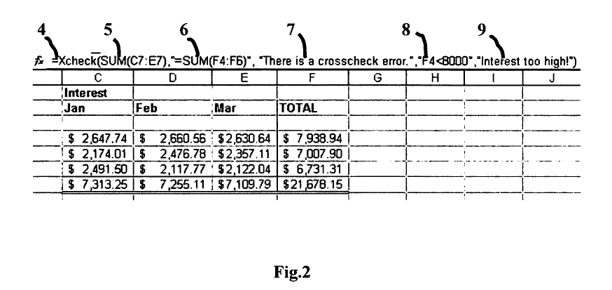

The embodiment shown in FIG. 2 is similar to the previous embodiment except that it contains two more optional arguments, 8 and 9. Argument 8, “F4<8000”, is another mathematical condition that is being tested; it is enclosed between quotation marks because it is treated as strings. It indicates that the contents of cell F4 must be less than 8000 in order for the condition to be true; in this example the contents of cell F4 is $7,938.94 so the condition is true. This condition is not dependent on argument 5 but optionally it could be dependent on it. Argument 9, “Interest too high” is enclosed between quotation marks because it is treated as strings. Since the answer was true to the previous condition, there is no error so this argument is not used any further.

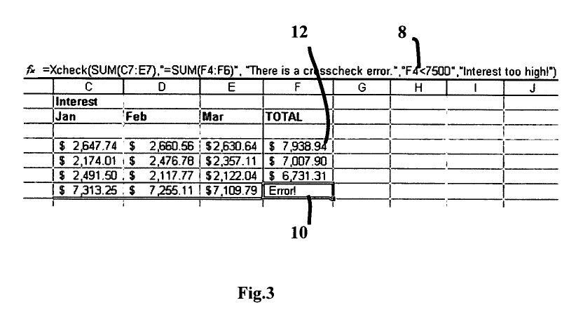

The embodiment shown in FIG. 3 is similar to the previous embodiment, except that the condition of argument 8 has been changed from F4<8000 to F4<7500, thereby creating a false result because the content of cell F4 is $7,938.94 that exceeds the condition to be tested of 7500. The validation results in the indication of an error 10 that is displayed in the active cell.

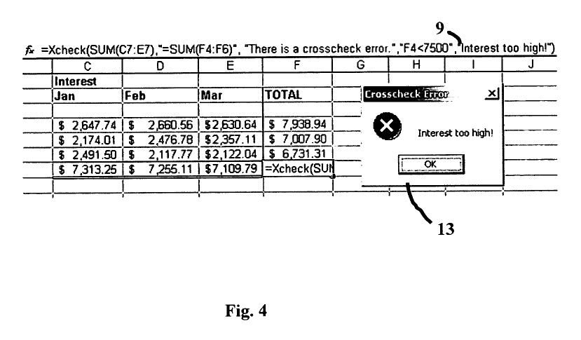

The embodiment shown in FIG. 4 is similar to the previous embodiment, except that an interface, 13, displays the message specified by argument 9 when the calculation is refreshed, in this example immediately after the formula is completed and entered in the active cell.

An example of instructions implementing a function of the preferred embodiment is given below:

```
Function Xcheck(Result1 As String, Test1 As String, Mess1 As String, _{—}
  Optional Test2 As String, Optional Mess2 As String)
  Dim e As Boolean
  Dim e2 As Boolean
  Dim m As String
  e = Evaluate(Result1 & Test1)
  If Test2 < > “ ” Then
    e2 = Evaluate(Test2)
  Else
    e2 = True
  End If
  Xcheck = Val(Evaluate(Result1))
  If Not e Then
    m = Mess1
    If m < > “ ” Then MsgBox m, vbCritical, “Crosscheck Error”
    Xcheck = “Error!”
  End If
  If Not e2 Then
      If m < > “ ” Then
        m = m & vbCrLf & Mess2
      Else
        m = Mess2
      End If
      If m < > “ ” Then MsgBox m, vbCritical, “Crosscheck Error”
      Xcheck = “Error!”
  End If
End Function
```

This is a Function rather than a Sub, so it can be called in any cell as a User Defined Function. Its name Xcheck, the arguments' names and all variables can be changed to suit the programmer.

Those skilled in the art will appreciate that the Evaluate function that is used is very powerful because it will compute any valid formula comprising any valid function with any valid argument and produce an exact result; it isn't limited to a comparison of equalities as previous art.

Those skilled in the art will also appreciate that some arguments are optional. Those skilled in the art will also appreciate that contrary to previous art, when an error is calculated an interface will appear even if the error is not located in the current worksheet. Those skilled in the art will also appreciate that the user may opt not to display an interface by entering an empty argument. Those skilled in the art will also appreciate that the messages are cumulative. Those skilled in the art will also appreciate that the correct result will appear as a value that can be formatted as a number, a date or currency and calculated in that fashion.

Although the present invention has been described in connection with various exemplary embodiments, those of ordinary skills in the art will understand that many modifications can be made thereto within the scope of the claims. Accordingly, it is not intended that the scope of the invention in any way be limited to the above description, but instead be determined entirely by the reference to the claims.

Those skilled in the art will appreciate that the present invention may be implemented in different environments such as handheld devices and it may be practiced in distributed computing environments, where tasks are performed by remote processing devices that are linked through a communications network. In a distributed environment, program modules may be located in both local and remote memory storage devices. Also the function may be contained in a separate add-in or a dynamic link library, a DLL. Also the error interface may contain information or mechanism to correct the error as well as hyperlinks to a help interface or to an Internet connection for example. Also there may me more arguments with more tests and different options such as displaying a context specific help interface. Also the first two arguments can be combined and the result programmatically extracted.

Having described my invention, what I claim as new and desire to secure by Letters Patents is:

1. A method that validates a spreadsheet formula by evaluating the result of any valid formula and comparing it with a condition in order to display the result if it agrees with the condition, or an error message if it does not agree.

2. A method as recited in claim 1, wherein there are optionally a plurality of conditions and messages.

3. A method as recited in claim 2, wherein if the result does not agree with a condition, an interface is displayed to inform of the type of error encountered.
